(19) United States
(12) Patent Application Publication
(10) Pub. No.: US 2012/0079012 A1
(43) Pub. Date: Mar. 29, 2012

(54) Multidimensional Object Finding System

(76) Inventors: Xianghui Wang, Fremont, CA (US); Wensheng Hua, Fremont, CA (US)

(21) Appl. No.: 13/246,835

(22) Filed: Sep. 27, 2011

Related U.S. Application Data
(60) Provisional application No. 61/386,564, filed on Sep. 27, 2010.

(51) Int. Cl. G06F 15/16

(52) U.S. Cl. 709/203

(57) ABSTRACT

The system helps to find one or more objects using multidimensional information.

### CROSS REFERENCE TO RELATED APPLICATIONS

The present application is related to, and claims priority of, provisional patent application, entitled: “a multi-dimensional object finding system”, with Ser. No. 61/386,564, filed on Sep. 27, 2010. The provisional patent application is hereby incorporated by reference in its entirety.

### DESCRIPTION

The system helps to find one or more objects using multidimensional information.

In one embodiment, for example, there are different TV advertisements shown on different TV channels at different localizations. A person saw one TV advertisement of a product, and he wants to buy the product, however, he does not know which phone number to call (in other case, he can not remember the 10 digit phone number shown on the TV advertisement). The system helps him find the phone number that he wants from the information about the advertisement, including, the time that the advertising is shown, the channel that the advertising is shown and the location of the person. For example, the user might use device, such as a smart cell phone. When he sees the advertisement from the TV, he can see a set of TV channels that is available around his current location. In a preferred embodiment, the channels are sorted by his favorite. Then he can click on the icon of the TV channel which automatically calls an agent who is selling the product close to his location.

In another embodiment, for example, a mobile phone user sees an advertisement on the side of the road. By pointing his cell phone towards the advertisement, the system can find out the information (including contact phone number, website, location etc.) of that advertisement (or several advertisement that is shown in the area). Then the user can do what ever he wants to do with the information that he gets, such as to call the contact phone number, to go to the location directly, to browse the website, etc.

In another embodiment, for example, a mobile phone user goes to a street with a lot of bars, he can use the system to find out which band is playing at which bar around him using information of (his location-from GPS, and time that he did the search).

One advantage of this invention is that it can be used in a way that does not change the existing information channel. For example, the TV show can be still broadcast and watched the same way as before. Just the users who uses the new system built according to this invention can have additional advantages.

In one embodiment, the system can be constructed using one or more web servers, one or more data access interface devices and one or more data input devices.

The data server(or servers) keeps information that users might be interested to search or find. The data server(s) also maintain data interfaces, for example Internet RPC calls, to exchange information with the user interface devices and the data input devices through Internet.

The data input device can be a computer connected to the Internet and thus be able to exchange data with the server. In one embodiment, the data input device has a web browser which can be used to input data. The data is sent to the data server through HTTP protocol.

After the server received the data, the server indexes it so that it can be easily searched and found. The server can use a relational database such as Oracle database to store the data.

When a user tries to find the information, he uses the data access interface device to find the object/information stored on the data server. In preferred embodiments the data access interface automatically detect various information of the user. For example, the data access device can be a smart mobile phone such as an iPhone from Apple. We a user tries to find an object/information, the data access interface automatically detects the user's location using GPS sensors, the time using an Internal clock, the orientation using a magnetometer, the user's id from the storage. The device can also let the user input certain information, such as click a button to indicate that user is interested in what is shown on the TV. Then the device will send the information to the data server through Internet. The server then will find the relevant object/information from its data storage, and send back to the data access device. The data access device will then display the information back to the user. Then the user can make a decision about what he wants to do with the information. For example, make a phone call to other the product/service that he is interested.

In one preferred embodiment of the invention, the user only needs to input minimal amount of information to obtain the object/information he/she is looking for. The user access device, such as the smart cell phone, automatically obtains information as much as possible. In the previous, location, time, orientation are automatic directly. The user access device and/or data server might also use its stored information to help user to reduce the amount of information he/she has to input. For example, the data access device or the data server can keep a list of favorite channels that a user watches. When a user tries to find some information on a TV advertisement, the favorite channels of the user is shown at top of a list.

### DETAILED IMPLEMENTATION

This section provides a detailed implementation one embodiment of the invention. However, the invention is not limited to these details.

The detailed implementation is about a TV user interaction/advertisement system.

The user uses a data accessing device to find/retrieve the information of his/her interest. The data accessing device can be a smart cell phone like an iPhone or smart remote control that is connected to the Internet, or a computer connected to the Internet. If the user uses a computer to watch the TV show he can use the computer itself as the data access device.

One the data access device, runs a software that enables user to

1, indicate his/her interest in finding information shown on the TV channel
2, and/or interact with the system to refine the information found by the system.
3, and/or use the information found by the system to do further actions such as to make a phone call to buy the product, browse a certain web page, complete a certain survey, save or bookmark the found information, etc.

The data server keeps information about the content and related information of the TV shows on different TV channels. For each TV channel, the data server keeps following table in a relational database. Not all the data tables and fields are necessary. These tables and fields are for one of the preferred embodiments.

channel_table:

1, channel_id (key)
2, channel_name
3, channel_type (broadcasting, cable, or satellite etc)
4, channel_icon_URL

channel_location_table:

1, channel_location_id (key)
2, location_id (foreign key)
3, channel_id (foreign key)

channel_section_table:

1, channel_section_id (key)
2, channel_location_id (foreign key)
3, start_time
4, end_time

advertisement_table:

1, advertisement_Id (key)
2, advertisement_name
3, general_phone_number
4, general_web_page_URL
5, advertisement_image_URL

advertisement_show_table:

1, advertisement_show_id (key)
2, advertisement_id (foreign key)
3, channel_location_id (foreign key)
4, start_time
5, end_time

advertisement_action_table:

1, advertisement_action_id (key)
2, advertisement_show_id (foreign key)
3, phone_number
4, web_page_URL
5, location_id(foreign key)

location_table:

1, location_id (key)
2, center_longitude
3, center_latitude
4, rough_radius
5, address
6, city
7, zip_code
8, state
9, country

user_table:

1, user_id
2, name
3, age
4, gender

user_favorite_channel_table

1, user_id (foreign key)
2, channel_id (foreign key)
3, score

The interaction between data access device and the data server works as the following:

1, when the user find some advertisement on the TV is interesting, he will push a button on the data access device. This operation will start the software if it is not started already. Then the data access device will collect the location (if available from GPS), and time and send these information together with user id to the server.

Then, the sever will figure out the channels and advertisement show the user might be possibly interested. First, find the longitude and latitude of the location. If GPS data is not available from the user data access device, it can estimate the user's location from ip-location lookup or using cell phone communication tower information. Secondly, server will find the channel that user might watched. The candidates can be found by joining the channel_location_table and location_table. One simple way to do that is to calculate the distance between the user's location and the center of the show location and select the show locations within a certain predetermined distance. Thirdly, the server will find out which advertisement show that the user probably watched based on the possible channels. Those can be found from the advertisement_show_table with constrain on showing time between the start_time and the end_time. Fourthly, the server will look up the advertisement action from the advertisement_action_table for the advertisement_show_ids from the previous step. Fifthly, the sever will lookup the advertisement_name in advertisement_table using the advertisement_ids. Sixthly, the server can lookup the user's favorite score for the involved channels.

After that, the server will send back information about all possible advertisements that the user might watched. The information can be kept in format of an array and each array element contains a list of

1, channel_id (key)
2, channel_name
3, channel_type (broadcasting, cable, or satellite etc)
4, channel_icon_URL
5, advertisement_name
6, advertisement_image_URL
6, phone_number
7, web_page_URL
8, user's favorite score of the channel

When the data access device receives the information from the server, it will display the result to the server. There are many ways to do this. One way is to display the channel icons (the icons can be obtained from channel_icon_URL and cached on the device locally) with the channel names. The channels can be sorted by the user's favorite score. Then the user can chose which channel he watched. Then, the data accessing device will display detailed information about the advertisement, including the advertisement image(obtained from internet), phone number to call, web page to visit. The data access device also provide other action options such as bookmark the advertisement to review later, send the advertisement to other people using email, or social networks, etc. The user then can call the phone number directly (if, for example, using a smart phone as the data access device), or visit the web site, bookmark the advertisement, share the advertisement etc.

The user's action then is sent to the data server for 1, keep action history (which can be used to calculate favorite score of a channel).

The data input device can be a computer connected to Internet. It can use a web page based interface to put/modify data saved on the data server. For example, the data server can use a JSP based server to achieve this. The server can also use remote procedure call(RPC) as the data interface to save/modify the data in its data base.

### More Features

The system can have additional features.

1, None advertisement actions. The system might also be used for none-advertisement actions. The system can also keep meta data (similar to the data, such as phone number, web sites about advertisement) about any shows on a TV channel and make them available in a similar way.
2, Visually active interfaces. The traditional TV shows have only passive information. There is no active components such as click-able items on a webpage. Data access device can be used to make TV shows actively acted upon. A image server can be used to keep a sequence of images for each TV channel. One click-able image maps can be attached to each of the images (if there is something interesting about the image). For example, the phone numbers shown at the bottom of an image can be made click-able. When user clicks on it a phone call can be made. The image server serves these images as web pages (or in a similar way). The image server keep the images using their time stamps. The data server can keep this image server and send the image server's URL to the data access device. The data access device can then display these images according to the display time in real time or according to user's go-back and or go-forward commands. Flash technologies can also be used to achieve similar effects. Click-able video can be used also. One can feed a click-able video stream to the data access device and the user can click on interesting things on it directly.
3, More Actions. The system can enable other user actions. For example, it can have a button for user to vote a score about how does he/she like the show. It can also be use to survey which channel is watched by different users. For example, the data access device might ask the user to click on the channel that the user is watching and send that data to the data server. The data server then calculates the percentage of users that are watching different channels. The data server can also do other statistical analysis. The data server might also enable the user to buy the item on the TV show/advertisement directly.
4, User behavior analysis. The data server can collect information about what channel the user watched and what advertisement the user acted on, what stuff the user bought, etc. These information can be used to serve different action items, different web pages, or other different personalized things to the user.

1. A system that helps users find or use objects, that compromises:
a computer device worked as the server which stores information of the objects that users might interested in finding,
a user interface device that a user uses to interact with the server

2. as in claim 1, wherein the user interface device collects multi-demential user information and sends it to the server

3. as in claim 2, wherein the user interface device collects part of the multi-demential user information automatically

4. as in claim 2, wherein the user interface device collects information include location, and time

5. as in claim 2, wherein the user interface device collects information include location, time and user id

6. as in claim 1, wherein computer device worked as the server maintains user specific information for each user

7. as in claim 1, the objects that user can find are shown on a TV.

8. as in claim 7, wherein the user interface device collects multi-demential user information and sends it to the server

9. as in claim 8, wherein the user interface device collects part of the multi-demential user information automatically

10. as in claim 9, wherein the user interface device collects information include location, time and user id

11. as in claim 10, where in the user only need to press one button to get the possible objects that he/she might be looking for

12. as in claim 11, the object returned to the user are sorted according to user's preference.

13. as in claim 11, where in the user is give objects that includes phone numbers that he/she can call

14. as in claim 13, where in the user is give objects that includes web sites that he/she can visit

15. as in claim 1, wherein the user interface device is a cell phone
